(19) United States
(12) Patent Application Publication
(10) Pub. No.: US 2003/0084111 A1
(43) Pub. Date: May 1, 2003

(54) Mail processing device, mail processing method, program for executing the processing method, and recording medium recording the program

(76) Inventor: Akira Yasuta, Nara-shi (JP)

Correspondence Address: BIRCH STEWART KOLASCH & BIRCH, PO BOX 747, FALLS CHURCH, VA, 22040-0747, US

(21) Appl. No.: 10/284,375

(22) Filed: Oct. 31, 2002

(30) Foreign Application Priority Data
Oct. 31, 2001 (JP) 2001-335289

(51) Int. Cl. G06F 15/16

(52) U.S. Cl. 709/206

(57) ABSTRACT

In a personal digital assistant 1, a mail 31, first and second attached files 32, 33, and their link ID information are stored in a mail memory area 19 in a RAM 16. Each link information indicates the relationship of the mail 31 and the first and second attached files 32, 33. Every time a right cursor key 66a is pressed, a central control unit 11 changes over the mail 31 and first and second attached files 32, 33 and displays any of them on a display screen 2 of a display device 13, based on each link information.

### BACKGROUND OF THE INVENTION

1. Technical Field of the Invention

The present invention relates to a mail processing device for displaying a mail and a file attached to the mail, a mail processing method therefor, a program for executing the processing method, and a recording medium recording the program.

As known well, functions of a personal digital assistant (PDA) include sending and receiving electronic mails, and displaying the message text of each electronic mail and the content of a file attached to the electronic mail on a display screen. Since the display screen is small, the message text or the content of each attached file is displayed one by one as selected. Accordingly, if plural files are attached to a mail, the attached files are listed on the display screen as icons or a table of contents, along with the message text. When any of the icons or a certain item in the table of contents is selected, the content of an attached file which corresponds to the selected icon or item is shown on the screen. In order to view the content of a different attached file on the display screen, a user goes back to the display of the message text and the icons or the table of contents, and selects an icon or an item of the table of contents all over again.

A related technology is disclosed in Japanese Patent Application Laid-open No. H11-187442. While the table of contents of mails is displayed on the screen, a user selects an item in the table of contents in order to view the text of a mail corresponding to the selected item. Following this step, the user can view the text of each mail by changing them over by a simple operation, without returning to the table of contents of mails.

However, according to the conventional knowledge, whenever a user wants to view the content of another file on the display screen, the user has to go back to the display of the icons or the table of contents and to select an icon or an item in the table of contents again. Each such process repeatedly requires screen scrolling, cursor moving or other operations, which results in complicated operations and a long operation time.

In addition, the technology disclosed in the above-mentioned publication is merely capable of changing over and displaying the text of mails. Hence, if a mail and attachment files attached to the mail are received, it is impossible to display the mail text and the contents of the attached files by efficiently changing them over with a simple operation.

### SUMMARY OF THE INVENTION

The present invention is devised in the light of these conventional problems. It is hence an object thereof to provide a mail processing device capable of displaying the message text of a mail and the content of each file attached to the mail by efficiently changing them over with a simple operation, a mail processing method therefor, a program for executing this processing method, and a recording medium recording this program.

A mail processing device of the present invention comprises means for inputting a mail and at least one file attached to the mail, and means for relating the mail and attached file in a ring and generating relational data showing this ring relation.

In the device of the invention having such configuration, the relational data shows the ring relation of the mail and attached file. Therefore, display of the mail and attached file is changed over one after another according to the relational data, so that the mail and attached file can be displayed sequentially and repeatedly. Notably, this display changeover operation can be effected efficiently by such a simple operation as to give display changeover instructions.

Another mail processing device of the invention comprises: means for displaying a mail and at least one file attached to the mail; means for instructing display changeover of the mail and attached file which are related in a ring, the changeover being instructed sequentially in one direction along the ring; and means for controlling display of the mail and attached file so as to display each of the mail and attached file on the display means by changing them over sequentially in one direction along the ring, the changeover being effected in response to display changeover instructions and based on preset relational data showing the ring relation.

According to the device of the invention having such configuration, the control means displays each of the mail and attached file on the display means by changing them over sequentially in one direction along the ring. This changeover operation is effected in response to display changeover instructions given by the instructing means, based on the preset relational data showing the ring relation. Therefore, the mail and attached file can be displayed sequentially and repeatedly. Notably, this display changeover operation can be effected efficiently by such a simple operation as to give display changeover instructions.

Still another mail processing device of the invention comprises: means for displaying a mail and at least one file attached to the mail; means for instructing display changeover of the mail and attached file which are related in a ring, the changeover being instructed sequentially in either a forward direction or a backward direction along the ring; and means for controlling display of the mail and attached file so as to display each of the mail and attached file on the display means by changing them over sequentially in the instructed direction, the changeover being effected in response to display changeover instructions in either the forward direction or the backward direction and based on preset relational data showing the ring relation.

In this case, the mail and attached file are changed over and displayed sequentially in either the forward direction or the backward direction along the ring. Therefore, the mail and attached file can be viewed one after another by being sequentially changed over and displayed in a forward order. In addition, the mail and attached file can be viewed in a reverse order by being sequentially changed over and displayed in a backward order.

Regarding the present invention, the mail processing device further comprises means for storing positions of the mail and attached file which are previously displayed on the display means. In this device, the control means allows the display means to redisplay each of the mail and attached file which are previously displayed, based on the positions of the mail and attached file stored in the storage means, with contents to be redisplayed being identical to the previously displayed ones.

In this case, the storage means stores the positions of the mail and attached file which are previously displayed on the display means. Based on the stored positions of the mail and attached file, it is possible to redisplay the display content of any of the mail and attached file immediately, by redisplaying the display content which is identical to the previously displayed one.

Also, the mail processing device of the invention further comprises means for storing display contents of the mail and attached file which are previously displayed on the display means. In this device, the control means allows the display means to redisplay each of the mail and attached file which are previously displayed, by redisplaying the display content of each of the mail and attached file stored in the storage means.

In this case, the storage means stores the display contents of the mail and attached file which are previously displayed on the display means. Then, it is possible to redisplay any of the display contents immediately, by redisplaying the corresponding one of the stored display contents.

Further regarding the mail processing device of the invention, the storage means stores positions of the mail and attached file which are previously displayed on the display means. If display contents of the mail and attached file are not stored in the storage means, the control means allows the display means to redisplay each of the mail and attached file which are previously displayed, based on the positions of the mail and attached file stored in the storage means, with contents to be redisplayed being identical to the previously displayed ones.

It is assumed herein that the storage means does not have sufficient memory capacity to store the display contents of the mail and attached file which are previously displayed. In this situation, the storage means stores the positions of the mail and attached file which are previously displayed on the display means. Namely, the storage means stores the positions whose amount of data is smaller. On the basis of the stored positions of the mail and attached file, the display means is immediately allowed to display any of the display contents which are identical to the previously displayed ones.

In the invention, the control means allows the display means to display a serial number of the attached file which is being displayed.

With indication of the serial number of the attached file, the user can recognize which attached file is displayed.

Further in the invention, the control means allows the display means to display the total number of files attached to the mail.

With indication of the total number of files attached to the mail, the user can recognize how many files are attached to the mail.

Additionally in the invention, the instructing means is also used to instruct processing of a content displayed on a screen of the display means.

In this case, the instructing means is used not only to give instructions for changing over the display but also to instruct processing of the content displayed on the screen of the display means. As a result, it is possible to simplify the instructing means.

Now, with respect to the mail processing method, a method of the present invention comprises the steps of inputting a mail and at least one file attached to the mail, and relating the mail and attached file in a ring and generating relational data showing this ring relation.

According to such method of the invention, the relational data shows the ring relation of mail and attached file. Therefore, display of the mail and attached file is changed over one after another according to the relational data, so that the mail and attached file can be displayed sequentially and repeatedly. Notably, this display changeover operation can be effected efficiently by such a simple operation as to give display changeover instructions.

Another mail processing method of the invention comprises the steps of: displaying a mail and at least one file attached to the mail on a screen; instructing display changeover of the mail and attached file which are related in a ring, such that the changeover is effected sequentially in one direction along the ring; and controlling display of the mail and attached file so as to display each of the mail and attached file on the screen by changing them over sequentially in one direction along the ring, the changeover being effected in response to display changeover instructions and based on preset relational data showing the ring relation.

According to such method of the invention, the mail and attached file are changed over and displayed sequentially in one direction along the ring, on the basis of the relational data. Therefore, the mail and attached file can be displayed sequentially and repeatedly. Notably, this display changeover operation can be effected efficiently by such a simple operation as to give display changeover instructions.

Still another mail processing method of the invention comprises the steps of: displaying a mail and at least one file attached to the mail on a screen; instructing display changeover of the mail and attached file which are related in a ring, such that the changeover is effected sequentially in either a forward direction or a backward direction along the ring; and controlling display of the mail and attached file so as to display each of the mail and attached file on the screen by changing them over sequentially in the instructed direction, the changeover being effected in response to display changeover instructions in either the forward direction or the backward direction and based on preset relational data showing the ring relation.

Herein, the mail and attached file can be viewed one after another by being sequentially changed over and displayed in a forward order. In addition, the mail and attached file can be viewed in a reverse order by being sequentially changed over and displayed in a backward order.

Regarding the invention, the mail processing method further comprises the step of storing positions of the mail and attached file which are previously displayed on the screen. In this method, the control step comprises allowing the screen to redisplay each of the mail and attached file which are previously displayed, based on the stored positions of the mail and attached file, with contents to be redisplayed being identical to the previously displayed ones.

According to this method, it is possible to redisplay any of the display contents immediately, by redisplaying the display content which is identical to that of the previously displayed one, based on the stored positions of the mail and attached file.

Also, the mail processing method of the invention further comprises the step of storing display contents of the mail and attached file which are previously displayed on the screen. In this method, the control step comprises allowing the screen to redisplay each of the mail and attached file which are previously displayed, by redisplaying the stored display content of each of the mail and attached file.

Thus, it is possible to redisplay any of the display contents immediately, by redisplaying the corresponding one of the stored display contents.

Further regarding the mail processing method of the invention, the storage step comprises storing positions of the mail and attached file which are previously displayed on the screen. If display contents of the mail and attached file are not stored in the storage step, the control step comprises allowing the screen to redisplay each of the mail and attached file which are previously displayed, based on the stored positions of the mail and attached file, with contents to be redisplayed being identical to the previously displayed ones.

It is assumed herein that there is not sufficient memory capacity to store the display contents of the mail and attached file which are previously displayed. In this situation, the storage step stores the positions of the mail and attached file which are previously displayed. On the basis of the stored positions, this method immediately displays any of the display contents which are identical to the previously displayed ones.

In the invention, the control step comprises allowing the screen to display a serial number of the attached file which is being displayed.

With this indication, the user can recognize which attached file is displayed.

Further in the invention, the control step comprises allowing the screen to display the total number of files attached to the mail.

With this indication, the user can recognize how many files are attached to the mail.

The present invention also includes a program for executing the above mail processing method.

The invention further includes a recording medium recording a program for executing the above mail processing method.

In other words, the invention not only includes the mail processing device and the mail processing method, but also includes the program for realizing this method, and the recording medium recording this program. With the use of such program and recording medium, it is possible to achieve the same functions and effects as obtained by the mail processing device and the mail processing method of the invention.

Examples of the recording medium include mask ROM, flash ROM, other semiconductor memory devices, IC card, hard disk, flexible disk, MO disk, CDROM, DVDROM, and others. Any other type of recording medium may be used as far as the program can be recorded.

### BRIEF DESCRIPTION OF THE DRAWINGS

FIG. 1 is an external view of a personal digital assistant according to the first embodiment of the present invention.

FIG. 2 is a block diagram showing a configuration of the personal digital assistant.

FIG. 3 is a block diagram showing a state of the personal digital assistant being connected to a mail server through a personal computer or the like.

FIG. 4 represents a mail and attached files received by the personal digital assistant in the first embodiment.

FIG. 5 is a flowchart showing a procedure of generating relational data for relating the mail and attached files.

FIG. 6 is a block diagram showing a state of the personal digital assistant being connected directly to a mail server.

FIG. 7 is a flowchart showing a procedure for changing over the display in the first embodiment.

FIG. 8 represents a display screen showing the message text of the mail in the first embodiment.

FIG. 9 represents a display screen showing the content of the first attached file in the first embodiment.

FIG. 10 represents a display screen showing the content of the second attached file in the first embodiment.

FIG. 11 is a flowchart showing a procedure of selecting between the screen changeover process and the processing of the content shown on the display screen, to be performed by the personal digital assistant.

FIG. 12 represents a display screen to be presented when the processing of the display content is selected.

FIG. 13 represents a mail and attached files received by a personal digital assistant in the second embodiment of the present invention.

FIG. 14 shows a composition of the display content memory area of the RAM in the personal digital assistant.

FIG. 15 shows a composition of the display position memory area of the RAM in the personal digital assistant.

FIG. 16 is a flowchart showing a procedure for changing over the display in the second embodiment.

FIG. 17 represents a display screen showing the message text of the mail in the second embodiment.

FIG. 18 represents a display screen showing the content of the first attached file in the second embodiment.

FIG. 19 represents a display screen showing the content of the second attached file in the second embodiment.

FIG. 20 is a flowchart showing a modified example of the procedure for changing over the display in the second embodiment.

FIG. 21 represents a mail and attached files received by a personal digital assistant in the third embodiment of the present invention.

FIG. 22 represents a display screen showing the message text of the mail in the third embodiment.

FIG. 23 represents a display screen showing the content of the first attached file in the third embodiment.

FIG. 24 represents a display screen showing the content of the second attached file in the third embodiment.

### DESCRIPTION OF PREFERRED EMBODIMENTS

Embodiments of the present invention are described in detail below, with reference to the accompanying drawings.

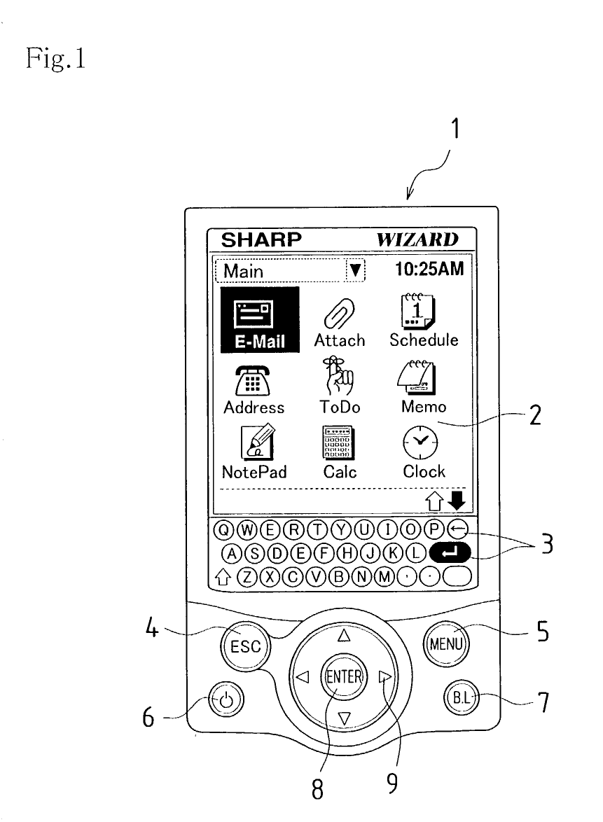

FIG. 1 is an external view of a personal digital assistant according to the first embodiment of the present invention. As shown in FIG. 1, a personal digital assistant (PDA) 1 of this embodiment comprises a display screen 2 composed of a liquid crystal display panel, an escape key 4 for interrupting the process of the device 1, a menu key 5 for fetching a menu, a power key 6 for turning on or off the power source, a backlight key 7 for turning on or off the backlight of the liquid crystal display panel, an enter key 8 for instructing execution of processes by the device 1, an up/down/left/right key 9 for allowing movement in the up, down, left and right directions on the display screen 2, and the like. A transparent touch panel, not shown, is put on the display screen 2. In response to pressure with a fingertip, touch pen, etc., the transparent touch panel detects the pressed position on the display screen 2. When the detected position corresponds to any icon or key on the display screen 2, the icon or key at this position is considered to be selected. In addition, when the detected position corresponds to any of character keys 3 on the display panel 2, the character key 3 at this position is considered to be selected.

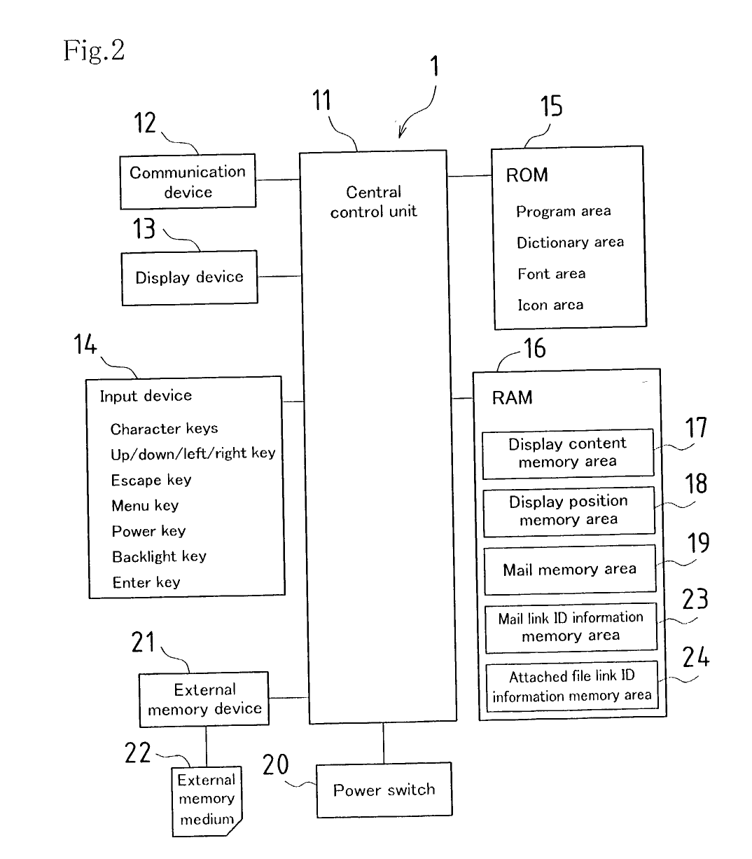

FIG. 2 is a block diagram showing a configuration of the personal digital assistant 1 of the embodiment. The personal digital assistant 1 comprises a central control unit 11 for controlling the personal digital assistant 1 comprehensively, a communication device 12 for sending and receiving data to and from a personal computer, a display device 13 having the display screen 2, an input device 14 including the keys 4, 5, 7, 8, 9 and the touch panel, a ROM 15 storing various programs, dictionary data for character conversion, fonts, icons and so on, a RAM 16 storing various data and serving as a work area, and a power switch 20 for turning on or off the power source in interlock with the power key 6. The RAM 16 includes a display content memory area 17, a display position memory area 18, a mail memory area 19, a mail link ID information memory area 23, and an attached file link ID information memory area 24. Further connected to the personal digital assistant 1 is an external memory device 21 for writing and reading data from a memory medium 22. The memory medium 22 may be a flexible disk, CDROM, IC card or the like. A program stored in this medium may be loaded in the RAM 16 and executed by the central control unit 11.

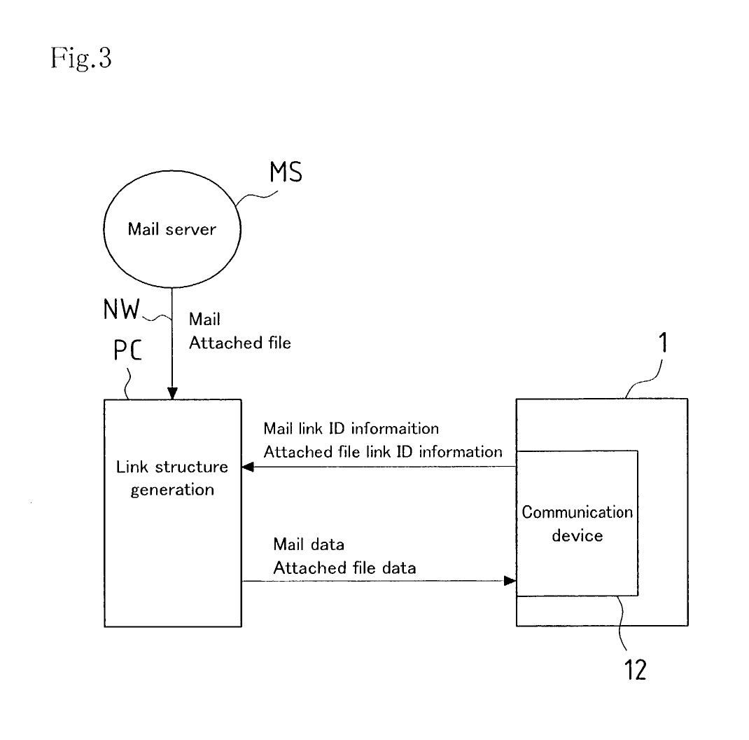

In this personal digital assistant 1, its communication device 12 is connected to a personal computer PC as shown in FIG. 3. The personal computer PC, which is connected to a mail server MS through a network NW, receives a mail from the mail server MS and transfers the mail to the personal digital assistant 1. At this time, the personal computer PC generates relational data for relating the mail and attached files, and supplies the relational data to the personal digital assistant 1.

For example, as shown in FIG. 4, a mail 31, and first and second attached files 32, 33 attached to the mail 31 are sent from the mail server MS to the personal computer PC.

The mail 31 is composed of sender's address information 31a, receiver's address information 31b, carbon copy information 31c, blind carbon copy information 31d, date information 31e, an unread/read status flag 31f, a subject name 31g, and a message text 31h. The first attached file 32 is composed of a file name 32a, date information 32b, a status flag 32c, and a content 32d. Similarly, the second attached file 33 is composed of a file name 33a, date information 33b, a status flag 33c, and a content 33d.

When the personal computer PC receives the mail 31 and the first and second attached files 32, 33 from the mail server MS, it demands link ID information relating to each of the mail 31 and the first and second attached files 32, 33 from the personal digital assistant 1, and receives the demanded link ID information from the personal digital assistant 1. The personal computer PC assigns the link ID information to the mail 31 and the first and second attached files 32, 33, so that the mail 31 and the first and second attached files 32, 33 are related with each other in a ring.

For example, the mail 31 is assigned with mail link ID information 31i which indicates the mail 31 itself, and next link ID information 31j. Further, the first attached file 32 is assigned with attached file link information 32e which indicates the first attached file 32 itself, and next link ID information 32f. Similarly, the second attached file 33 is assigned with attached file link information 33e showing the second attached file 33 itself, and next link ID information 33f.

The next link ID information 31j of the mail 31 is set to coincide with the attached file link ID information 32e of the first attached file 32. The next link ID information 32f of the first attached file 32 is set to coincide with the attached file link ID information 33e of the second attached file 33. The next link ID information 33f of the second attached file 33 is set to coincide with the mail link ID information 31i of the mail 31. As a result, the next link ID information 31j, 32f, 33f relate the mail 31 and the first and second attached files 32, 33 sequentially in one direction, as shown by the arrows.

The personal computer PC sends the mail 31 and the first and second attached files 32, 33 to the personal digital assistant 1, together with their link ID information.

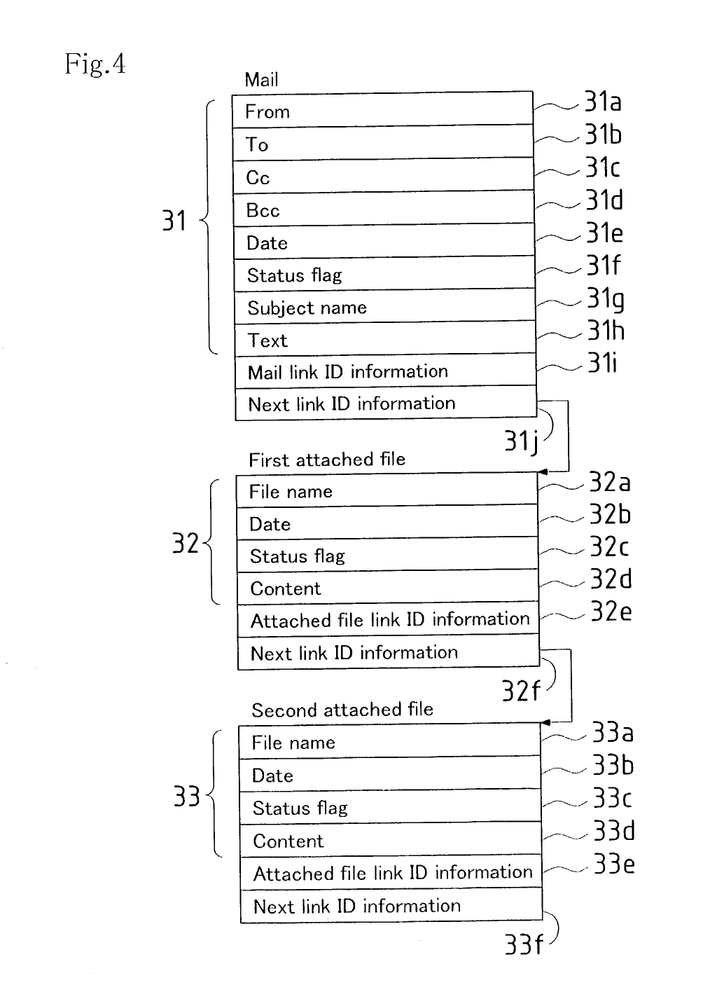

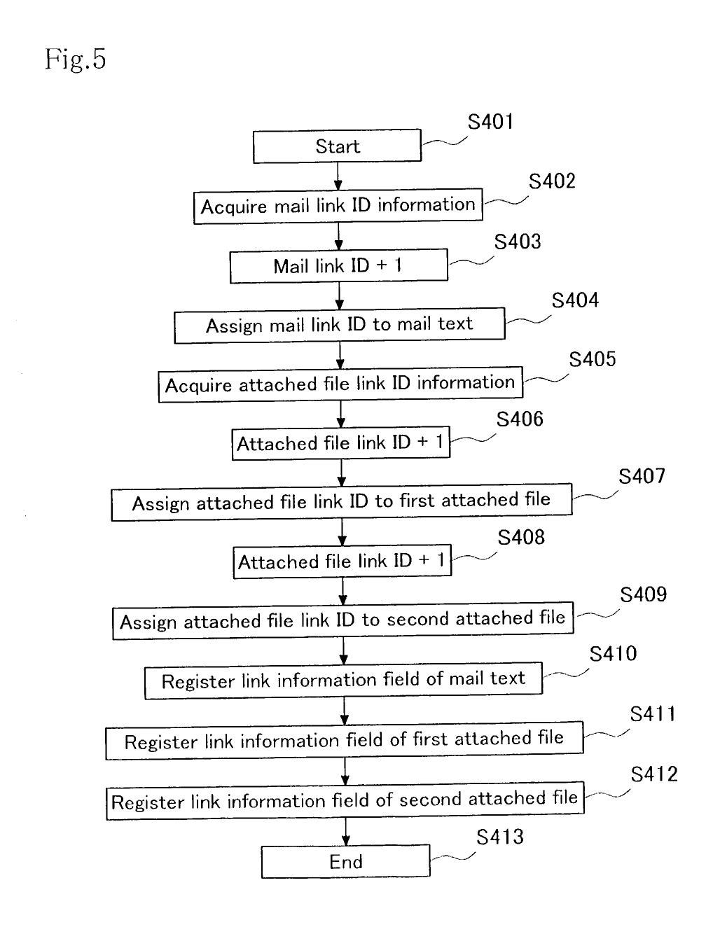

Now, the relational data generating procedure performed by the personal computer PC and the personal digital assistant 1 is specifically described below, referring to the flowchart in FIG. 5.

The process in FIG. 5 starts when the personal computer PC receives the mail 31 and the first and second attached files 32, 33 from the mail server MS (step S401). Then, the personal computer PC demands their link ID information from the personal digital assistant 1. In response, the personal digital assistant 1 reads out mail link ID information from the mail link ID information memory area 23 in the RAM 16 (step S402) and updates the mail link ID information by adding thereto the value of 1. While this updated mail link ID information is sent as mail link ID information 31i from the communication device 12 to the personal computer PC, the personal digital assistant 1 updates the mail link ID information in the mail link ID information memory area 23 (step S403). On receiving the mail link ID information 31i, the personal computer PC adds the received mail link ID information 31i to the mail 31 (step S404).

Next, in the personal digital assistant 1, attached file link ID information is read out from the attached file link ID information memory area 24 in the RAM 16 (step S405), and updates the attached file link ID information by adding thereto the value of 1. While this updated information is sent to the personal computer PC as attached file link ID information 32e, the personal digital assistant 1 updates the attached file link ID information in the attached file link ID information memory area 24 (step S406). On receiving the attached file link ID information 32e, the personal computer PC adds the received attached file link ID information 32e to the first attached file 32 (step S407). In a similar procedure, attached file link ID information is updated again (step S408) and added to the second attached file 33 as attached file link ID information 33e (step S409).

Further, in the personal computer PC, the attached file link ID information 32e indicating the first attached file 32 is added to the mail 31 as the next link ID information 31j (step S410). Also, the attached file link ID information 33e indicating the second attached file 33 is added to the first attached file 32 as the next link ID information 32f (step S411), and the mail link ID information 31i indicating the mail 31 is added to the second attached file 33 as the next link ID information 33f (step S412). Thereafter, in the data formats as shown in FIG. 4, the personal computer PC sends the mail 31 and the first and second attached files 32, 33, along with their individual link ID information.

In the personal digital assistant 1, the mail 31 and the first and second attached files 32, 33 are received by the communication device 12, together with their link ID information. The received data are stored in the mail memory area 19 in the RAM 16. This step concludes the process of FIG. 5 (step S413).

Incidentally, if only one file is attached, steps S408, S409, and S412 are omitted. On the other hand, if three or more files are attached, steps S408, S409, and S412 are repeated by the number of additional attachment files.

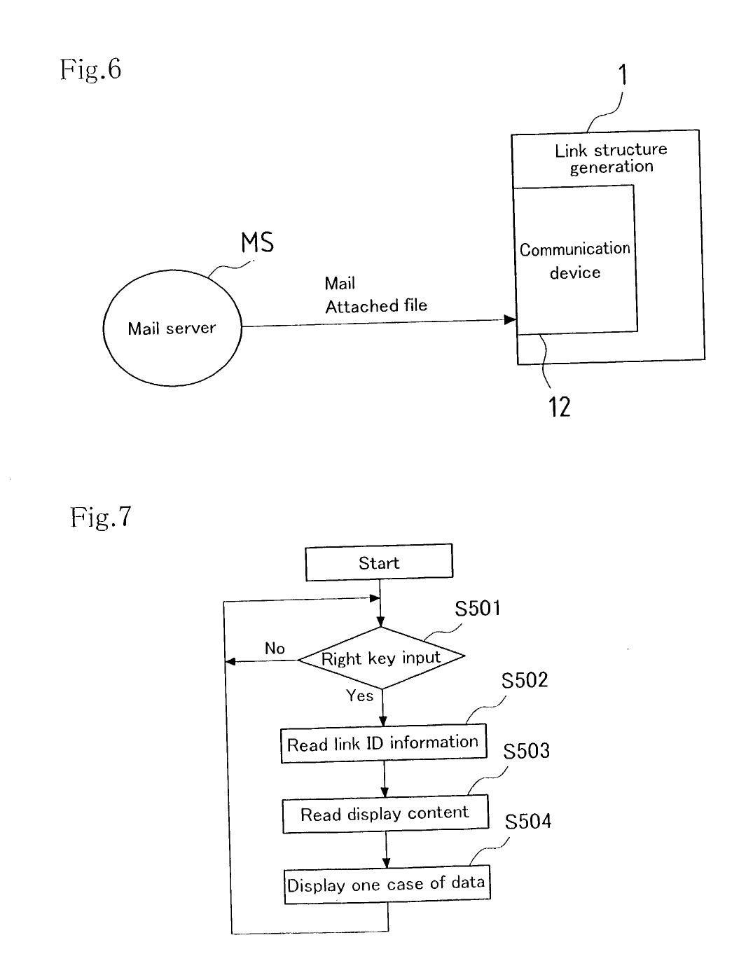

Referring to the arrangement of FIG. 6, the communication device 12 of the personal digital assistant 1 is connected to the mail server MS by way of the network NW, whereby a mail is directly transferred from the mail server MS to the personal digital assistant 1. In this case, the relational data for relating the mail and attached files is generated by the personal digital assistant 1, in the same procedure according to the flowchart in FIG. 5.

Through the above-described procedure, the mail 31, the first and second attached files 32, 33, and their link ID information are stored in the mail memory area 19 in the RAM 16 of the personal digital assistant 1. Once this is done, it is possible to display the mail 31 and the first and second attached files 32, 33 on the display screen 2 of the display device 13 by changing them over with a simple operation.

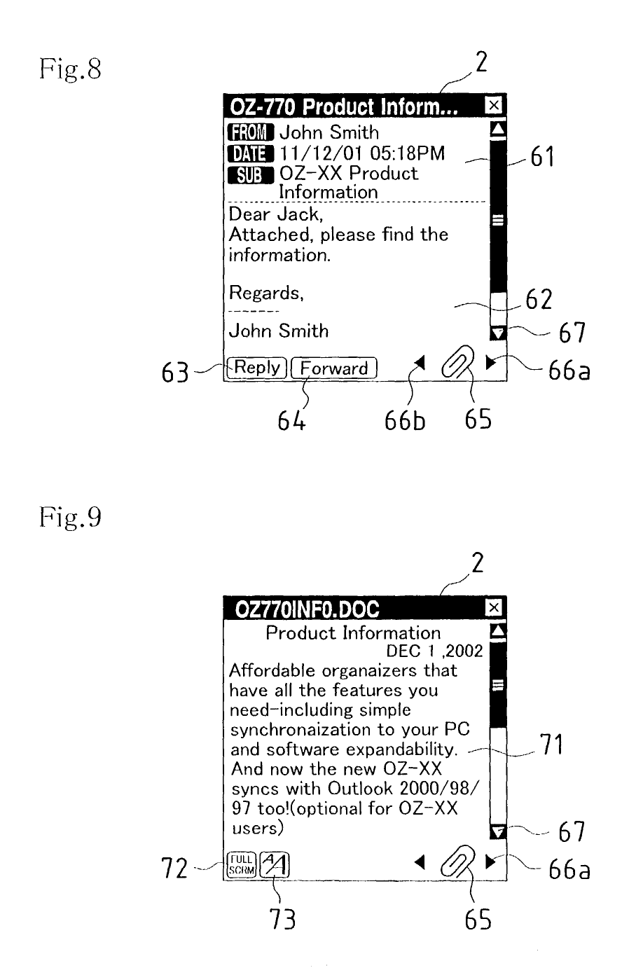

The display changeover process is explained by referring to the flowchart in FIG. 7. With this display changeover process, the contents of the display screen 2 of the display device 13 are understood to be changed over in the sequence of FIGS. 8, 9 and 10.

First, the central control unit 11 reads out the message text 31h and others of the mail 31 from the mail memory area 19 in the RAM 16, and displays the message text 31h and others on the display screen 2 of the display device 13 as shown in FIG. 8. The display screen 2 includes: a header information display region 61 for displaying the sender, date, subject name and others of the mail 31; a message display region 62 for displaying the message text of the mail 31; a button 63 for guiding the user to a reply mail creation process; a button 64 for guiding the user to a forwarded mail creation process; an icon 65 showing the presence of an attached file; right and left cursor keys 66a, 66b; up and down cursor keys 67, etc.

In this state, the central control unit 11 waits until the right cursor key 66a is pressed down (“No” at step S501). When the right cursor key 66a is pressed down (“Yes” at step S501), the central control unit 11 reads the next link ID information 31j added to the mail 31, from the mail memory area 19 in the RAM 16 (step S502). Since the next link ID information 31j refers to the first attached file 32, the central control unit 11 further reads out the content 32d and others of the first attached file 32 from the mail memory area 19 (step S503), and displays the content 32d and others on the display screen 2 of the display device 13 as shown in FIG. 9 (step S504). Thereafter, the process returns to step S501. This display screen 2 includes a display region 71 for displaying the content of the first attached file 32, a button 72 for guiding the user to a cell width changing process, a button 73 for changing the font size, and the like.

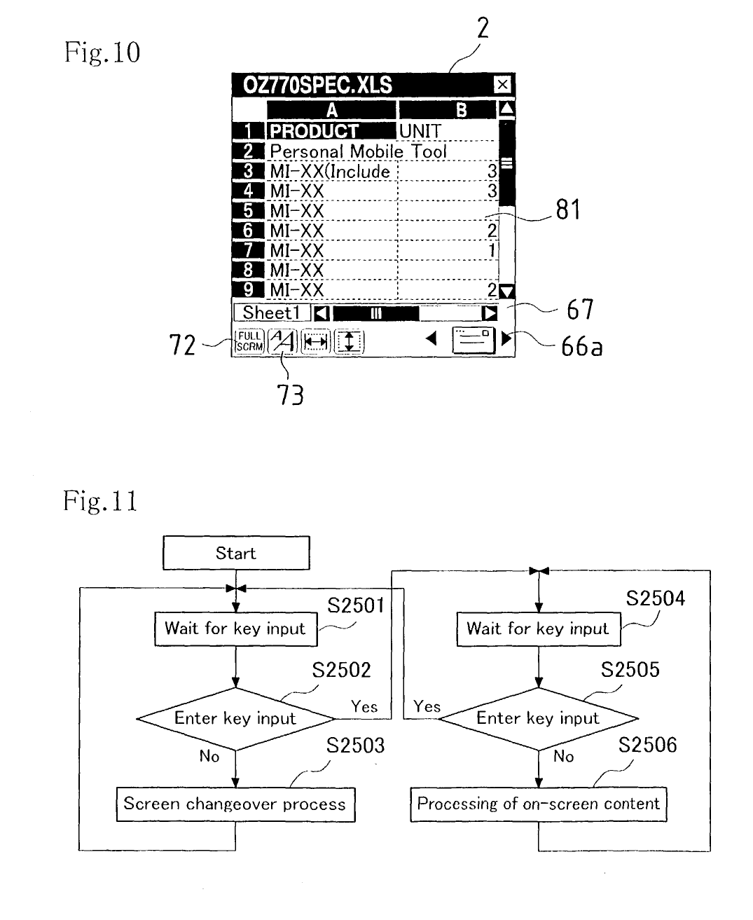

When the right cursor key 66a is pressed again (“Yes” at step S501), the central control unit 11 reads out the next link ID information 32f added to the first attached file 32, from the mail memory area 19 in the RAM 16 (step S502). Since the next link ID information 32f refers to the second attached file 33, the central control unit 11 reads out the content 33d and others of the second attached file 33 from the mail memory area 19 (step S503), and displays the content 33d and others on the display screen 2 of the display unit 13 as shown in FIG. 10 (step S504). Thereafter, the process returns to step S501. This display screen 2 includes, among others, a display region 81 for displaying the content of the second attached file 33.

When the right cursor key 66a is pressed yet again (“Yes” at step S501), the central control unit 11 reads out the next link ID information 33f added to the second attached file 33, from the mail memory area 19 in the RAM 16 (step S502). Since the next link ID information 33f refers to the mail 31, the central control unit 11 reads out the message text 31h and others of the mail 31 from the mail memory area 19 (step S503), and displays the message text 31h and others on the display screen 2 of the display unit 13 as shown in FIG. 8 (step S504). Thereafter, the process returns to step S501.

Thus, every time the right cursor key 66a is pressed, the mail 31 and the first and second attached files 32, 33 are sequentially and repeatedly changed over and displayed in the same manner.

In this embodiment, therefore, the mail and attached files can be sequentially and repeatedly changed over and displayed by a simple operation of pressing the right cursor key 66a.

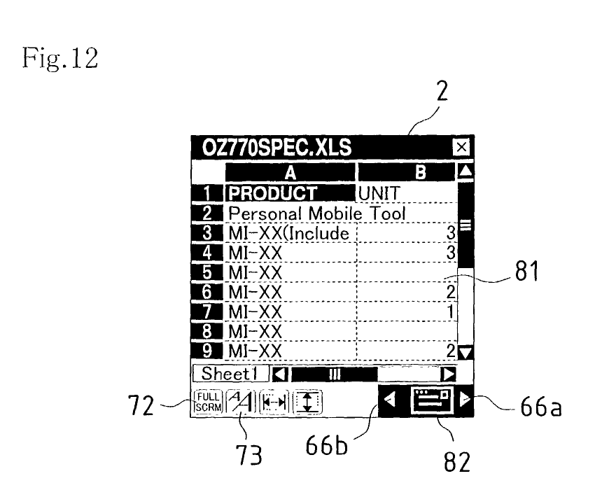

Incidentally, if it were possible to process the content on the display screen 2 simultaneously with the screen changeover process as shown in the flowchart in FIG. 7, these operations would be likely to be confused and result in wrong operations. To prevent such confusion, the screen changeover process and the processing of the content shown on the display screen 2 are clearly distinguished from each other, according to the flowchart in FIG. 11.

For example, suppose the content shown in FIG. 10 is displayed on the display screen 2. In this state, the central control unit 11 waits for key input (step S2501). When a key is pressed, the central control unit 11 judges if the pressed key is the enter key 8 or not (step S2502). If not (“No” at step S2502), the central control unit 11 proceeds to the screen changeover process shown in the flowchart in FIG. 7 (step S2503).

If the pressed key is the enter key 8 (“Yes” at step S2502), the central control unit 11 proceeds to processing of the content displayed on the display screen 2. At this time, the central control unit 11 highlights a lower right region 82 on the display screen 2 as shown in FIG. 12, telling the user that the operation has turned to processing of the content displayed on the display screen 2. In the meantime, the central control unit 11 waits for next key input (step S2504). When a key is pressed again, the central control unit 11 judges if the pressed key is the enter key 8 or not (step S2505). In the case of the enter key 8 (“Yes” at step S2505), the original display screen 2 in FIG. 10 appears again, and the process goes back to step S2501. If it is not the enter key 8 (“No” at step S2505), the central control unit 11 responds to the pressed key and executes the processing of the content on the display screen 2 (step S2506). For example, when the right or left scroll key 66a or 66b is pressed on the display screen 2 shown in FIG. 12, the content 33d of the second attached file 33 is scrolled in the right or left direction. When the button 73 is pressed, the size of the displayed font is changed.

In this manner, the screen changeover process and the processing of the content shown on the display screen 2 are selected alternately, depending on whether the enter key 8 is pressed or not. While the screen changeover process is selected, the process proceeds according to the flowchart in FIG. 7. On the other hand, while the processing of the content shown on the display screen 2 is selected, the content on the display screen 2 is processed in response to depression of various keys on the display screen 2. This arrangement not only helps to prevent wrong operations, but also enables the right and left scroll keys 66a, 66b to be used in both the screen changeover process and the processing of the content on the display screen 2.

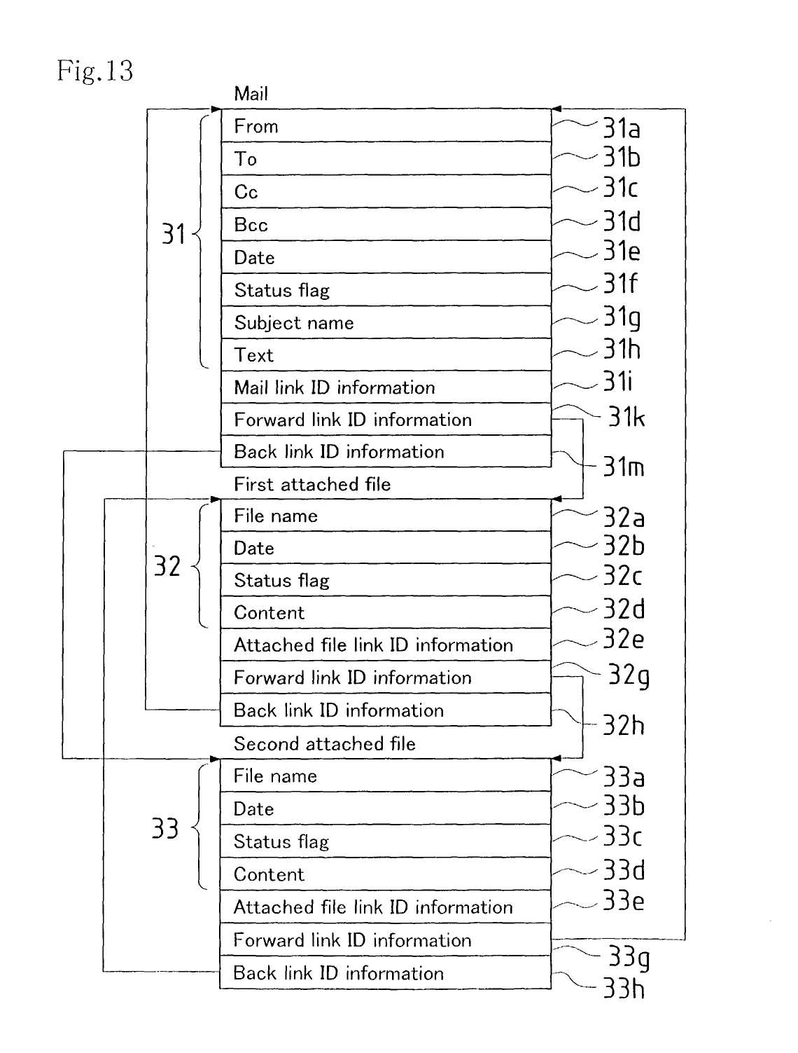

Referring now to FIGS. 13 to 19, the second embodiment of the invention is described.

This embodiment is applied to the personal digital assistant 1 shown in FIGS. 1 and 2, and designed to receive a mail from the mail server MS through the network NW as shown in FIG. 3, or to receive a mail directly from a mail server MS as shown in FIG. 6.

Regarding this embodiment, FIG. 13 shows the mail 31, the first and second attached files 32, 33, and link ID information concerning each of the mail and attached files. Herein, each link ID information is different from that shown in FIG. 4. Instead of the next link ID information 31j mentioned in FIG. 4, the mail 31 carries forward link ID information 31k and back link ID information 31m. Also, instead of the next link ID information 32f, the first attached file 32 carries forward link ID information 32g and back link ID information 32h. Likewise, instead of the next link ID information 33f, the second attached file 33 carries forward link ID information 33g and back link ID information 33h.

For example, with respect to the mail 31, the forward link ID information 31k and the back link ID information 31m are set to coincide respectively with the attached file link ID information 32e of the first attached file 32 and the attached file link ID information 33e of the second attached file 33. With respect to the first attached file 32, the forward link ID information 32g and the back link ID information 32h are set to coincide respectively with the attached file link ID information 33e of the second attached file 33 and the mail link ID information 31i of the mail 31. With respect to the second attached file 33, the forward link ID information 33g and the back link ID information 33h are set to coincide respectively with the mail link ID information 31i of the mail 31 and the attached file link ID information 32e of the first attached file 32. As a result, the forward link ID information 31k, 32g, 33g and the back link ID information 31m, 32h, 33h relate the mail 31 and the first and second attached files 32, 33 to each other, in the forward direction and the backward direction as indicated by arrows.

Similar to the case of FIG. 4, the mail 31 and the first and second attached files 32, 33 are related according to the flowchart in FIG. 5. At step S410, however, the attached file link ID information 32e of the first attached file 32 and the attached file link ID information 33e of the second attached file 33 are added to the mail 31, respectively as the forward link ID information 31k and the back link ID information 31m. At step S411, the attached file link ID information 33e of the second attached file 33 and the mail link ID information 31i of the mail 31 are added to the first attached mail 32, respectively as the forward link ID information 32g and the back link ID information 32h. At step S412, the mail link ID information 31i of the mail 31 and the attached file link ID information 32e of the first attached file 32 are added to the second attached mail 33, respectively as the forward link ID information 33g and the back link ID information 33h.

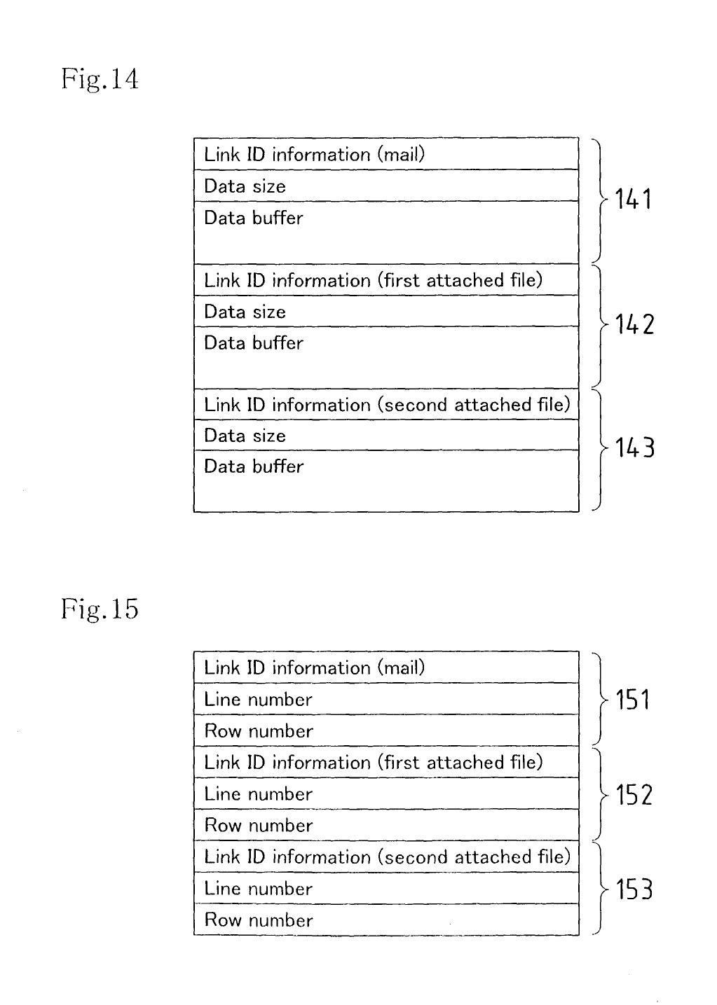

In addition, this embodiment utilizes the display content memory area 17 and the display position memory area 18 in the RAM 16. The display content memory area 17 includes a mail information area 141, a first attached file information area 142, and a second attached file information area 143 as shown in FIG. 14. Each of the information areas 141, 142, 143 stores the mail link ID information or attached file link ID information which indicates the mail or either attached file displayed on the display screen 2, the data size of the display content of the message text 31h or contents 32d, 33d displayed on the display screen 2, and the display content itself of the message text 31h or contents 32d, 33d. The display content is herein understood to mean the entire display content of the message text 31h or contents 32d, 33d being read out from the mail memory area 19. Therefore, the size of the display content memory area 17 and the number of information areas are different, depending on the number of files attached to the mail 31.

Turning to FIG. 15, the display position memory area 18 also includes a mail information area 151, a first attached file information area 152, and a second attached file information area 153. Each of the information areas 151, 152, 153 stores the mail link ID information indicating the mail or the attached file link ID information indicating each of the attached files, and the line number and/or row number corresponding to the upper left corner of the display portion of the display content shown on the display screen 2. The line number and/or row number corresponding to the upper left corner of the display portion is stored as the display start position of the display content. For changeover of the display screen 2, the line number and/or row number is used in order to match the display start position and the upper left corner of the display screen 2. When the display content of the message text 31h or contents 32d, 33d is scrolled on the display screen 2, the display start position of the display content is updated sequentially, and hence the line number and/or row number is updated sequentially.

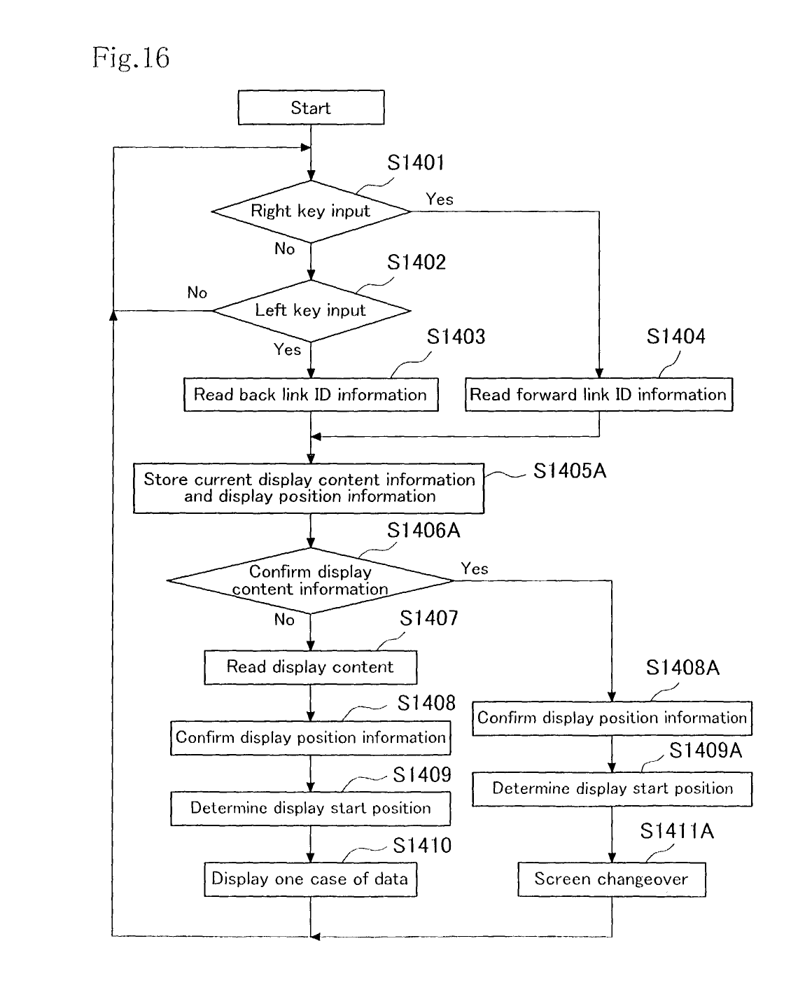

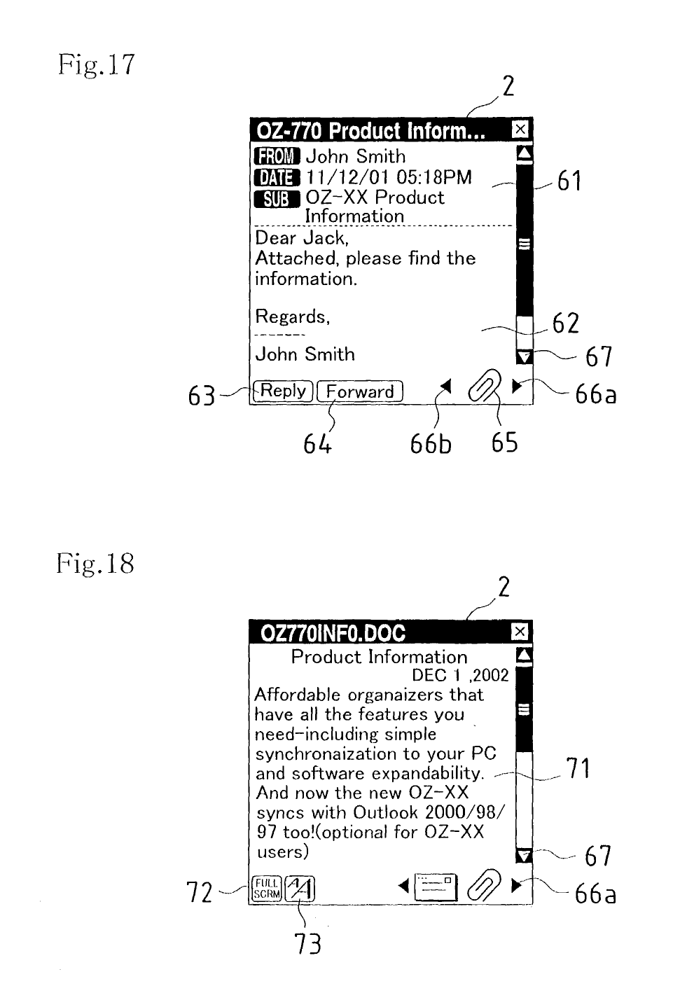

Now, regarding a procedure for changing over and displaying the mail 31 and the first and second attached files 32, 33 on the display screen 2 of the display device 13, description is made according to the flowchart in FIG. 16. By this display changeover, the contents on the display screen 2 of the display device 13 change over among those of FIGS. 17, 18 and 19.

To start with, the central control unit 11 reads out the message text 31h and others of the mail 31 from the mail memory area 19 in the RAM 16 and displays the display portion of the display content on the display screen 2, waiting until either of the right cursor key 66a or the left cursor key 66b is pressed (“No” at steps S1401, 1402). In this state, if the right cursor key 66a is pressed (“Yes” at step S1401), the central control unit 11 reads the forward link ID information 31k added to the mail 31, from the mail memory area 19 in the RAM 16 (step S1404).

Besides, the central control unit 11 stores the information about the mail 31 shown on the display screen 2, into the display content memory area 17 and the display position memory area 18 in the RAM 16 (step S1405A). In this step, the display content of the message text 31h of the mail 31 may be or may not be stored in the display content memory area 17, depending on whether memory capacity of the display content memory area 17 is sufficient or insufficient. In whichever case, the mail link ID information 31i and the line number and/or row number corresponding to the upper left corner of the display portion of the message text 31h are always stored in the display position memory area 18.

Next, since the forward link ID information 31k of the mail 31 refers to the first attached file 32, the central control unit 11 checks whether the information about the first attached file 32 is already stored in the display content memory area 17. If not (“No” at step S1406A), the central control unit 11 reads out the content 32d and others of the first attached file 32 from the mail memory area 19 in the RAM 16 (step S1407). After confirming that the information about the first attached file 32 is not stored yet in the display position memory area 18 (step S1408), the central control unit 11 determines the beginning line and/or row of the display content of the content 32d as the display start position (step S1409). And finally, the display portion of the display content of the content 32d is displayed on the display screen 2 as shown in FIG. 18 (step S1410). Thereafter, the process returns to step S1401.

In succession, when the right cursor key 66a is pressed again, the central control unit 11 reads out the forward link ID information 32g of the first attached file 32, and stores the information about the first attached file 32 into the display content memory area 17 and the display position memory area 18. Subsequently, the display screen 2 displays the display portion of the content 33d of the second attached file 33 which is indicated by the forward link ID information 32g. When the right cursor key 66a is pressed yet again, the central control unit 11 reads out the forward link ID information 33g of the second attached file 33, and stores the information about the second attached file 33 into the display content memory area 17 and the display position memory area 18. Subsequently, the display screen 2 displays the display portion of the message text 31h of the mail 31 which is indicated by the forward link ID information 33g.

On the other hand, while the display screen 2 displays the display portion of the display content of the message text 31h of the mail 31, suppose that the left cursor key 66b is pressed (“Yes” at step S1402). In this case, the central control unit 11 reads out the back link ID information 31m added to the mail 31, from the mail memory area 19 in the RAM 16 (step S1403). Then, the central control unit 11 stores the information about the mail 31 displayed on the display screen 2, into the display content memory area 17 and the display position memory area 18 in the RAM 16 (step S1405A).

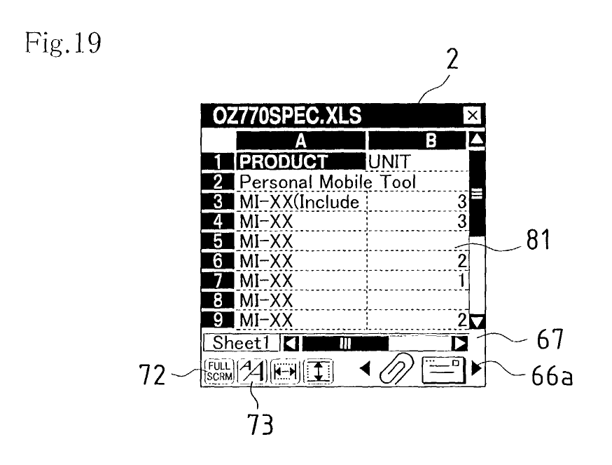

Next, since the back link ID information 31m of the mail 31 refers to the second attached file 33, the central control unit 11 checks whether the information about the second attached file 33 is already stored in the display content memory area 17. If not (“No” at step S1406A), the central control unit 11 reads out the content 33d and others of the second attached file 33 from the mail memory area 19 in the RAM 16 (step S1407). After confirming that the information about the second attached file 33 is not stored yet in the display position memory area 18 (step S1408), the central control unit 11 determines the beginning line and/or row of the display content of the content 33d as the display start position (step S1409). And finally, the display portion of the display content of the content 33d is displayed as shown in FIG. 19 (step S1410). Thereafter, the process returns to step S1401.

In succession, when the left cursor key 66b is pressed again, the central control unit 11 reads out the back link ID information 33h of the second attached file 33, and stores the information about the second attached file 33 into the display content memory area 17 and the display position memory area 18. Subsequently, the display screen 2 displays the display portion of the content 32d of the first attached file 32 which is indicated by the back link ID information 33h. When the left cursor key 66b is pressed yet again, the central control unit 11 reads out the back link ID information 32h of the first attached file 32, and stores the information about the first attached file 32 into the display content memory area 17 and the display position memory area 18. Subsequently, the display screen 2 displays the display portion of the message text 31h of the mail 31 which is indicated by the back link ID information 32h.

Therefore, with depression of the right cursor key 66a or the left cursor key 66b, the message text 31h of the mail 31, the content 32d of the first attached file 32, and the content 33d of the second attached file 33 are changed over and displayed sequentially either in the forward direction or the backward direction.

In this way, the information about the mail 31, first attached file 32, and second attached file 33 is stored in the display content memory area 17 and the display position memory area 18. Once this process is complete, the message text 31h and file contents 32d, 33d can be immediately displayed again, based on the contents stored in the display content memory area 17 and the display position memory area 18.

For example, the display content of the message text is redisplayed in the following manner. If the central control unit 11 judges that the information about the mail 31 is stored in the display content memory area 17 (“Yes” at step S1406A), it reads the display content of the message text 31h of the mail 31 from the display content memory area 17. Besides, the central control unit 11 reads out the line number and/or row number corresponding to the upper left corner of the display portion of the previously shown message text 31h, from the display position memory area 18 (step S1408A), and determines this line number and/or row number as the display start position (step S1409A). Eventually, the display portion of the display content of the message text 31h is displayed on the display screen 2 (step S1411A). Similarly, the display content of either attached file is redisplayed in the following manner. If the display content of the attached file is stored in the display content memory area 17, the central control unit 11 reads out the display content of this attached file from the display content memory area 17. Besides, the central control unit 11 reads out the line number and/or row number corresponding to the upper left corner of the display portion of the previously shown attached file, from the display position memory area 18 (step S1408A), and determines this line number and/or row number as the display start position (step S1409A). Eventually, the display portion of the display content of the attached file is displayed on the display screen 2 (step S1411A).

However, the display content of the message text 31h of the previously shown mail 31 may not be stored in the display content memory area 17, if the display content memory area 17 does not have sufficient memory capacity. Nevertheless, the line number and/or row number corresponding to the upper left corner of the display portion of the message text 31h is always stored in the display position memory area 18.

Under such circumstances, the central control unit 11 judges that the information about the mail 31 is not stored in the display content memory area 17 (“No” at step S1406A), and reads out the message text 31h of the mail 31 from the mail memory area 19 in the RAM 16 (step S1407). Next, the central control unit 11 reads out the line number and/or row number corresponding to the upper left corner of the display portion of the previously shown message text 31h, from the display position memory area 18 (step S1408), and determines this line number and/or row number as the display start position (step S1409). Eventually, the display portion of the display content of the message text 31h is displayed on the display screen 2 (step S1410). Similarly, the display content of a previously shown attached file is redisplayed even if its display content is not stored in the display content memory area 17. To effect the redisplay, the central control unit 11 reads out the attached file from the mail memory area 19 in the RAM 16. It also reads out the line number and/or row number corresponding to the upper left corner of the display portion of the attached file from the display position memory area 18, and determines this line number and/or row number as the display start position. Eventually, the display portion of the display content of the attached file is displayed on the display screen 2. As a result, it is possible to redisplay the previously shown display portion immediately. In each redisplay operation, the process of re-reading or redeveloping the mail 31, first attached file 32, and second attached file 33 from the mail memory area 19 in the RAM 16 can be almost omitted.

In the foregoing description, the display content memory area 17 stores the display contents of the message text 31h and contents 32d, 33d displayed on the display screen 2. Instead, the display content memory area 17 may store the display portion of the message text 31h displayed on the display screen 2, and the display portions of the contents 32d, 33d displayed on the display screen 2. In this modification, it is likewise possible to redisplay any previously shown display portion immediately.

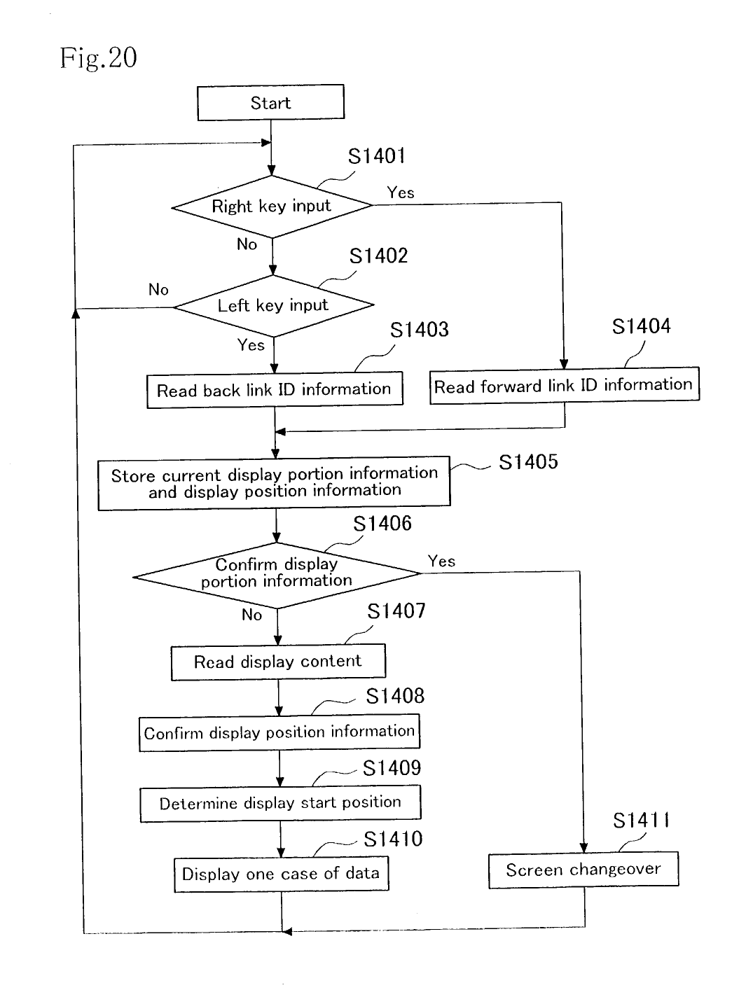

Now, regarding the case where the display content memory area 17 stores the display portion of the message text 31h and the display portions of the contents 32d, 33d, a relevant process is explained according to the flowchart in FIG. 20. In the flowchart in FIG. 20, the same steps as in FIG. 16 are identified with the same signs.

First, the central control unit 11 reads the message text 31h and others of the mail 31 from the mail memory area 19 in the RAM 16, and displays the display portion of the message text 31h on the display screen 2 of the display device 13 as shown in FIG. 17.

In this state, the central control unit 11 waits until either the right cursor key 66a or the left cursor key 66b is pressed (“No” at steps S1401, 1402). In the meantime, if the right cursor key 66a is pressed (“Yes” at step S1401), the central control unit 11 reads out the forward link ID information 31k added to the mail 31, from the mail memory area 19 in the RAM 16 (step S1404).

Besides, the central control unit 11 stores the information about the mail 31 displayed on the display screen 2, into the display content memory area 17 in the RAM 16 (step S1405). Namely, the mail link ID information 31i of the mail 31, the data size of the display portion of the message text 31h, and the display portion itself are stored in the display content memory area 17. If the display content memory area 17 cannot store the information about the mail 31 due to its limited available capacity, the mail link ID information 31i, and the line number and/or row number corresponding to the upper left corner of the display portion of the message text 31h are stored in the display position memory area 18.

Next, since the forward link ID information 31k of the mail 31 refers to the first attached file 32, the central control unit 11 checks whether the information about the first attached file 32 is already stored in the display content memory area 17. If not (“No” at step S1406), the central control unit 11 reads out the content 32d and others of the first attached file 32 from the mail memory area 19 in the RAM 16 (step S1407). After confirming that the information about the first attached file 32 is not stored yet in the display position memory area 18 (step S1408), the central control unit 11 determines the beginning line and/or row of the display content of the content 32d as the display start position (step S1409). Then, with the display start position aligned at the upper left corner of the display screen 2, the central control unit 11 displays the display portion of the display content of the content 32d on the display screen 2 as shown in FIG. 18 (step S1410). Thereafter, the process returns to step S1401.

In succession, when the right cursor key 66a is pressed again, the central control unit 11 reads out the forward link ID information 32g of the first attached file 32, and stores the information about the first attached file 32 into the display content memory area 17 or the display position memory area 18. Subsequently, the display screen 2 displays the display portion of the content 33d of the second attached file 33 which is indicated by the forward link ID information 32g. When the right cursor key 66a is pressed yet again, the central control unit 11 reads out the forward link ID information 33g of the second attached file 33, and stores the information about the second attached file 33 into the display content memory area 17 or the display position memory area 18. Subsequently, the display screen 2 displays the display portion of the message text 31h of the mail 31 which is indicated by the forward link ID information 33g.

On the other hand, while the display screen 2 displays the display portion of the display content of the message text 31h of the mail 31, suppose that the left cursor key 66b is pressed (“Yes” at step S1402). In this case, the central control unit 11 reads out the back link ID information 31m added to the mail 31, from the mail memory area 19 in the RAM 16 (step S1403). Then, the central control unit 11 stores the information about the mail 31 displayed on the display screen 2 into the display content memory area 17 and the display position memory area 18 in the RAM 16 (step S1405).

Next, since the back link ID information 31m of the mail 31 refers to the second attached file 33, the central control unit 11 checks whether the information about the second attached file 33 is already stored in the display content memory area 17. If not (“No” at step S1406), the central control unit 11 reads out the content 33d and others of the second attached file 33 from the mail memory area 19 in the RAM 16 (step S1407). After confirming that the information about the second attached file 33 is not stored yet in the display position memory area 18 (step S1408), the central control unit 11 determines the beginning line and/or row of the display content of the content 33d as the display start position (step S1409). And finally, the display portion of the display content of the content 33d is displayed as shown in FIG. 19 (step S1410). Thereafter, the process returns to step S1401.

In succession, when the left cursor key 66b is pressed again, the central control unit 11 reads out the back link ID information 33h of the second attached file 33, and stores the information about the second attached file 33 into the display content memory area 17 or the display position memory area 18. Subsequently, the display screen 2 displays the display portion of the content 32d of the first attached file 32 which is indicated by the back link ID information 33h. When the left cursor key 66b is pressed yet again, the central control unit 11 reads out the back link ID information 32h of the first attached file 32, and stores the information about the first attached file 32 into the display content memory area 17 or the display position memory area 18. Subsequently, the display screen 2 displays the display portion of the message text 31h of the mail 31 which is indicated by the back link ID information 32h.

Therefore, with depression of the right cursor key 66a or the left cursor key 66b, the message text 31h of the mail 31, the content 32d of the first attached file 32, and the content 33d of the second attached file 33 are changed over and displayed sequentially either in the forward direction or the backward direction.

Herein, for the display changeover on the display screen 2, the information relating to each of the mail 31, the first attached file 32 and the second attached file 33 is stored in the display content memory area 17 or the display position memory area 18. Accordingly, the message text 31h of the mail 31, the content 32d of the first attached file 32, the content 33d of the second attached file 33 and the like can be redisplayed immediately, based on the memory contents in the display content memory area 17 or the display position memory area 18.

For example, if the central control unit 11 judges that the information about the mail 31 is stored in the display content memory area 17 (“Yes” at step S1406), it reads the display portion of the message text 31h of the previously shown mail 31 from the display content memory area 17, and displays this display portion on the display screen 2 (step S1411). Similarly, the content of one of the attached files is redisplayed in the following manner. If the display portion of the content of the previously shown attached file is stored in the display content memory area 17, the central control unit 11 can read out this display portion from the display content memory area 17, and display the display portion on the display screen 2. Thus, the previously shown display portion can be redisplayed immediately.

However, the display portion of the message text 31h of the previously shown mail 31 may not be stored in the display content memory area 17, if the display content memory area 17 does not have sufficient memory capacity. Nevertheless, the line number and/or row number corresponding to the upper left corner of the display portion of the message text 31h is always stored in the display position memory area 18.

Under such circumstances, the central control unit 11 judges that the information about the mail 31 is not stored in the display content memory area 17 (“No” at step S1406), and reads out the message text 31h of the mail 31 from the mail memory area 19 in the RAM 16 (step S1407). Next, the central control unit 11 reads out the line number and/or row number corresponding to the upper left corner of the display portion of the previously shown message text 31h, from the display position memory area 18 (step S1408), and determines this line number and/or row number as the display start position (step S1409). Eventually, the display portion of the display content of the message text 31h is displayed on the display screen 2 (step S1410). Similarly, the display portion of a previously shown attached file is redisplayed even if its display portion is not stored in the display content memory area 17. To effect the redisplay, the central control unit 11 reads out the attached file from the mail memory area 19 in the RAM 16. It also reads out the line number and/or row number corresponding to the upper left corner of the display portion from the display position memory area 18, and determines this line number and/or row number as the display start position. Eventually, the display portion of the display content of the attached file is displayed on the display screen 2. As a result, it is possible to redisplay the previously shown display portion immediately.

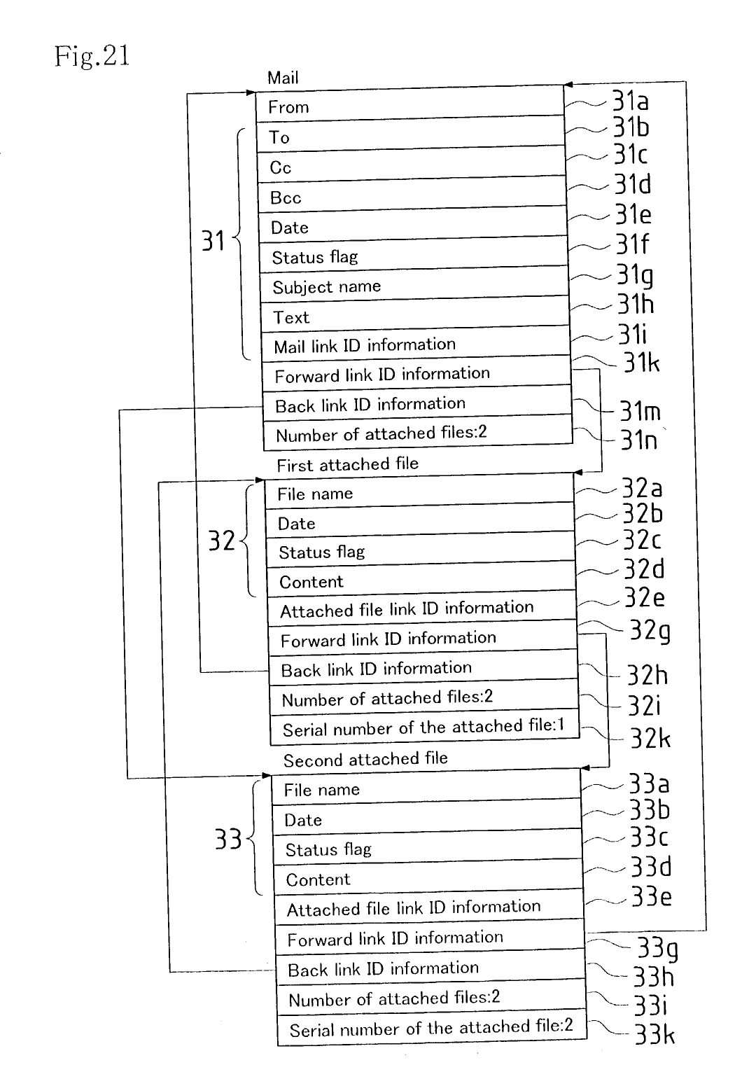

Referring now to FIGS. 21 to 24, the third embodiment of the invention is described below.

This embodiment is applied to the personal digital assistant 1 shown in FIGS. 1 and 2, and designed to receive a mail from the mail server MS through the network NW as shown in FIG. 3, or to receive a mail directly from the mail server MS as shown in FIG. 6.

Regarding this embodiment, FIG. 21 shows the mail 31, the first and second attached files 32, 33, link ID information concerning each of the mail and attached files, and others. Compared with the embodiment shown in FIG. 13, the mail 31 further carries total number information 31n about attached files. The first attached file 32 additionally carries total number information 32i about attached files and serial number information 32k about attached files. The second attached file 33 additionally carries total number information 33i about attached files and serial number information 33k about attached files.

As two files are attached to the mail 31, each of the attached file total number information 31n, 32i, 33i is set to the value of 2. In addition, the first attached file 32, which is the first of the two attached files, is set to have the value of 1 as the attached file serial number information 32k. Likewise, the second attached file 33, which is the second of the two attached files, is set to have the value of 2 as the attached file serial number information 33k.

Such total number information and serial number information about attached files is created and added to the mail 31 and the first and second attached files 32, 33, when these mail and attached files are related to each other.

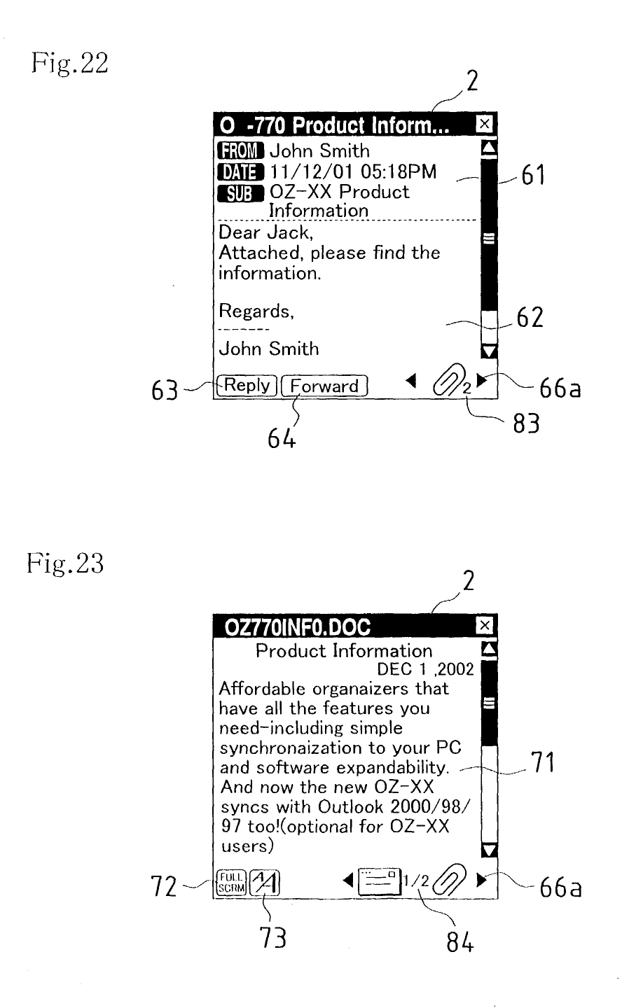

The composition of each link ID information about the mail and attached files is same as the one shown in FIG. 13. The procedure for changing over and displaying the mail 31 and the first and second attached files 32, 33 on the display screen 2 is executed according to the flowchart in FIG. 16. However, the display contents on the display screen 2 are different from those of FIGS. 17, 18 and 19, and are changed over among those of FIGS. 22, 23 and 24.

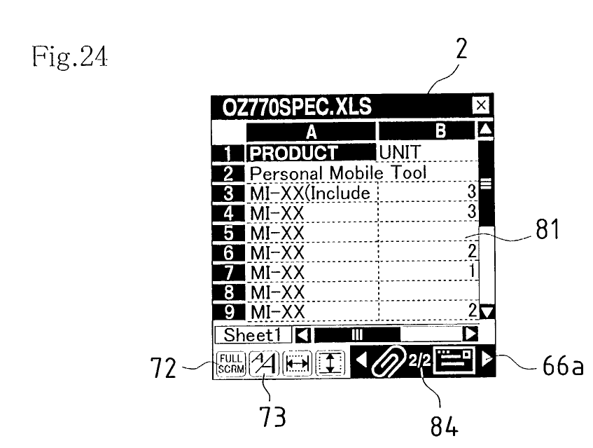

As for FIG. 22, the display on the display screen 2 shows the message text 31h of the mail 31. In a lower right display region 83 of this display screen 2, the central control unit 11 displays the value of 2, according to the attached file total number information 31n of the mail 31. Turning to FIG. 23, the display on the display screen 2 shows the first attached file 32. In a lower right display region 84 of this display screen 2, the central control unit displays the value of 2 and the value of 1, respectively according to the attached file total number information 32i and the attached file serial number information 32k of the first attached file 32. Referring next to FIG. 24, the display on the display screen 2 shows the second attached file 33. In the lower right display region 84 of this display screen 2, the central control unit 11 displays the value of 2 and the value of 2, respectively according to the attached file total number information 33i and the attached file serial number information 33k of the second attached file 33.

It should be understood that the display screen 2 in FIG. 24 is highlighted in the vicinity of the lower right region 84, as on the display screen 2 shown in FIG. 12. This highlighting informs the user that the process has turned to the processing of the content displayed on the display screen 2.

With the display of the total number and serial number of attached files, the user can see how many files are attached to the mail and which attached file is being displayed on the display screen 2.

Incidentally, the present invention is not limited to these embodiments alone, but may be modified in various manners. For example, in addition to the personal digital assistant (PDA), the invention may be applied to other types of terminals. Besides, since attached files are available in various types and formats, the invention may be arranged to extract and display only the text of each attached file.

Moreover, the invention includes not only the mail processing device, but also a mail processing method, a program for executing the processing method, and a recording medium recording such program.

The program is recorded on a magnetic disk, optical disk, hard disk built in a computer, or other recording media. Otherwise, the program is transmitted and received through a communication network. A computer, a terminal device with a built-in microprocessor, or the like is capable of practicing the invention by carrying out the program which is read out from the recording medium or received through the communication network. In the case of a system composed of plural computers or terminal devices or a system composed of the Internet, more than one processes can be distributed among and executed by these computers or terminal devices. Thus, the program can be applied not only to a single terminal such as a computer, but also to the system.

The recording medium includes mask ROM, EPROM, EEPROM, flash ROM and other semiconductor memory devices, IC card, hard disk, flexible disk, MO, CD, MD, DVD and other optical disks, magnetic tapes, or the like. The type of recording medium is not particularly limited as far as the program can be recorded.

The invention may be embodied in various other forms without departing from the spirit or essential characteristics thereof. The present embodiments are therefore illustrative and not restrictive, the scope of the invention being defined by the appended claims rather than by the foregoing description. All changes which come within the meaning and range of equivalency of the claims are therefore intended to be embraced therein.

This application is based on Patent Application No. 2001-335289 filed in Japan, and the entire contents thereof are incorporated herein by reference. Likewise, the entire contents of the reference cited herein are incorporated specifically by reference.

What is claimed is:

1. A mail processing device comprising:
means for inputting a mail and at least one file attached to the mail; and
means for relating the mail and attached file in a ring and generating relational data showing this ring relation.

2. A mail processing device comprising:
means for displaying a mail and at least one file attached to the mail;
means for instructing display changeover of the mail and attached file which are related in a ring, the changeover being instructed sequentially in one direction along the ring; and
means for controlling display of the mail and attached file so as to display each of the mail and attached file on the display means by changing them over sequentially in one direction along the ring, the changeover being effected in response to display changeover instructions and based on preset relational data showing the ring relation.

3. A mail processing device comprising:
means for displaying a mail and at least one file attached to the mail;
means for instructing display changeover of the mail and attached file which are related in a ring, the changeover being instructed sequentially in either a forward direction or a backward direction along the ring; and
means for controlling display of the mail and attached file so as to display each of the mail and attached file on the display means by changing them over sequentially in the instructed direction, the changeover being effected in response to display changeover instructions in either the forward direction or the backward direction and based on preset relational data showing the ring relation.

4. The mail processing device of claim 2 or 3, further comprising:
means for storing positions of the mail and attached file which are previously displayed on the display means,
wherein the control means allows the display means to redisplay each of the mail and attached file which are previously displayed, based on the positions of the mail and attached file stored in the storage means, with contents to be redisplayed being identical to the previously displayed ones.

5. The mail processing device of claim 2 or 3, further comprising:
means for storing display contents of the mail and attached file which are previously displayed on the display means,
wherein the control means allows the display means to redisplay each of the mail and attached file which are previously displayed, by redisplaying the display content of each of the mail and attached file stored in the storage means.

6. The mail processing device of claim 5,
wherein the storage means stores positions of the mail and attached file which are previously displayed on the display means, and
if display contents of the mail and attached file are not stored in the storage means, the control means allows the display means to redisplay each of the mail and attached file which are previously displayed, based on the positions of the mail and attached file stored in the storage means, with contents to be redisplayed being identical to the previously displayed ones.

7. The mail processing device of any one of claims 2 to 6,
wherein the control means allows the display means to display a serial number of the attached file which is being displayed.

8. The mail processing device of any one of claims 2 to 7,
wherein the control means allows the display means to display the total number of files attached to the mail.

9. The mail processing device of claim 2 or 3,
wherein the instructing means is also used to instruct processing of a content displayed on a screen of the display means.

10. A mail processing method comprising the steps of:
inputting a mail and at least one file attached to the mail; and
relating the mail and attached file in a ring and generating relational data showing this ring relation.

11. A mail processing method comprising the steps of:
displaying a mail and at least one file attached to the mail on a screen;
instructing display changeover of the mail and attached file which are related in a ring, such that the changeover is effected sequentially in one direction along the ring; and
controlling display of the mail and attached file so as to display each of the mail and attached file on the screen by changing them over sequentially in one direction along the ring, the changeover being effected in response to display changeover instructions and based on preset relational data showing the ring relation.

12. A mail processing method comprising the steps of:
displaying a mail and at least one file attached to the mail on a screen;
instructing display changeover of the mail and attached file which are related in a ring, such that the changeover is effected sequentially in either a forward direction or a backward direction along the ring; and
controlling display of the mail and attached file so as to display each of the mail and attached file on the screen by changing them over sequentially in the instructed direction, the changeover being effected in response to display changeover instructions in either the forward direction or the backward direction and based on preset relational data showing the ring relation.

13. The mail processing method of claim 11 or 12, further comprising the step of:
storing positions of the mail and attached file which are previously displayed on the screen,
wherein the control step comprises allowing the screen to redisplay each of the mail and attached file which are previously displayed, based on the stored positions of the mail and attached file, with contents to be redisplayed being identical to the previously displayed ones.

14. The mail processing method of claim 11 or 12, further comprising the step of:
storing display contents of the mail and attached file which are previously displayed on the screen,
wherein the control step comprises allowing the screen to redisplay each of the mail and attached file which are previously displayed, by redisplaying the stored display content of each of the mail and attached file.

15. The mail processing method of claim 14,
wherein the storage step comprises storing positions of the mail and attached file which are previously displayed on the screen, and
if display contents of the mail and attached file are not stored in the storage step, the control step comprises allowing the screen to redisplay each of the mail and attached file which are previously displayed, based on the stored positions of the mail and attached file, with contents to be redisplayed being identical to the previously displayed ones.

16. The mail processing method of any one of claims 11 to 15,
wherein the control step comprises allowing, the screen to display a serial number of the attached file which is being displayed.

17. The mail processing method of any one of claims 11 to 16,
wherein the control step comprises allowing the screen to display the total number of files attached to the mail.

18. A program for executing the mail processing method as set forth in any one of claims 10 to 17.

19. A recording medium which records a program for executing the mail processing method as set forth in any one of claims 10 to 17.
